(19) United States
(12) Patent Application Publication
(10) Pub. No.: US 2007/0080670 A1
(43) Pub. Date: Apr. 12, 2007

(54) Power dissipation management in linear regulators

(76) Inventor: Martin F. Galinski III, Santa Clara, CA (US)

Correspondence Address: SAWYER LAW GROUP LLP, P O BOX 51418, PALO ALTO, CA, 94303, US

(21) Appl. No.: 11/247,034

(22) Filed: Oct. 11, 2005

(51) Int. Cl. G05F 1/00

(52) U.S. Cl. 323/273

(57) ABSTRACT

A method, circuit, and system for managing power dissipation in a linear regulator are provided. The method includes receiving an input voltage at a pass element of the linear regulator, delivering an output voltage through the pass element, determining an output current through the pass element, and measuring a voltage drop across the pass element. The circuit includes a pass element that is operable to receive an input voltage and deliver an output voltage and a first amplifier and a second amplifier that are operable to monitor power dissipation through the pass element. The system includes an integrated circuit, a power source that is operable to power the integrated circuit, and a linear regulator that is operable to regulate a power output from the power source to the integrated circuit.

### FIELD OF THE INVENTION

The present invention relates generally to voltage regulators. More particularly, the present invention is directed to management of power dissipation in linear regulators.

### BACKGROUND OF THE INVENTION

A voltage regulator is a circuit designed to deliver a constant output voltage despite changes in load, temperature, and/or power supply. A linear regulator is a type of voltage regulator that has a transistor, often referred to as the “pass element,” biased in the “linear region” of the regulator, i.e., the pass element operates in the presence of both high voltage and high current and acts like a variable resistor.

FIG. 1 illustrates a block-level diagram of a generic linear regulator 100 that includes a pass element 102, an error amplifier 104, a feedback 106, and a reference voltage 108. Pass element 102 is used as one-half of a potential divider to control the output voltage of linear regulator 100. Error amplifier 104 compares feedback 106 to reference voltage 108 in order to adjust the input to pass element 102 and keep the output voltage relatively constant.

Linear regulators require an input voltage at least some minimum amount higher than the desired output voltage. That minimum amount is called the dropout voltage. For example, a linear regulator may have an output voltage of 3 volts (V), but can only maintain this if the input voltage remains above 5V. Hence, the linear regulator's dropout voltage is 5V−3V=2V. When the input voltage is less than 2V above the desired output voltage, low dropout (LDO) regulators must be used.

Reduced cost, complexity, and output noise associated with linear regulators make them ideal for use in many applications, such as automotive products, portable electronic devices, industrial applications, and networking equipment. For example, in the automotive industry, a low dropout voltage is necessary during cold-crank conditions where the battery voltage can be below 6V. Additionally, battery-powered portable electronic devices, such as cellular phones and laptops, require efficient voltage regulation to prolong battery life.

As shown in FIG. 1, linear regulators were initially designed with internal pass elements. The need to manage moderate to high output currents, however, led to the design of linear regulators with external pass elements. An external pass element offers designers advantages unattainable with the monolithic approach. One advantage is the pass element's die area in a given package can be increased because the control circuitry is separate. This leads to lower dropout voltages at higher output currents. Another advantage is the decrease in junction-to-case thermal resistance, which allows for higher output currents without a heat sink.

Unfortunately, difficulties have arisen in designing linear regulators with external pass elements. In particular, during fault conditions, such as a short circuit condition, an over current condition, or an over-voltage condition, a larger power is placed across the pass element. With excessive power dissipation, the temperature of the external pass element can exceed the maximum allowable temperature, which could damage the element or degrade its reliability. Since the pass element is external, accurate and quick temperature sensing becomes complex and expensive.

Traditionally, circuit protection has been restricted to various methods of current limiting. One method of current limiting is to maintain constant output power. Hence, as the output voltage drops, the maximum output current is increased to maintain a constant power. This method, however, is the most stressful on the pass element because the power across it will be exponentially increased above the maximum expected operating condition when the current is increased.

Maintaining a constant current as the output voltage drops is another commonly used current limiting scheme. This method increases the maximum power dissipation to the input voltage multiplied by the current limit threshold. As a result, this always requires the pass element to dissipate more power in a fault condition than what the device requires for normal operation.

Re-entrant or foldback current limiting is another method of current limiting. This method attempts to reduce the amount of power dissipated by reducing the current dependent on the output voltage. During over-current conditions where the output is not shorted to zero, the power dissipated across the switch will exceed the maximum power dissipation allowed during normal operation.

Hence, in order to handle fault conditions, all of the current limiting methods above will require heat sinking or over-sizing of the pass element to protect the circuit from being damaged by excessive power dissipation. Accordingly, there is a need for linear regulators that are able to manage power dissipation across external pass elements without requiring over-sized pass elements or heat sinking. The present invention addresses such a need.

### SUMMARY OF THE INVENTION

A method, circuit, and system for managing power dissipation in linear regulators are disclosed. In one aspect, a method of managing power dissipation in a linear regulator is disclosed. The method includes receiving an input voltage at a pass element of the linear regulator, delivering an output voltage through the pass element, determining an output current through the pass element, and measuring a voltage drop across the pass element. In some embodiments, the pass element is external to the regulator.

In another aspect, a linear regulator is disclosed. The linear regulator includes a pass element that is operable to receive an input voltage and deliver an output voltage. The linear regulator also includes a first amplifier and a second amplifier that are operable to monitor power dissipation through the pass element by determining an output current through the pass element at the first amplifier and measuring a voltage drop across the pass element at the second amplifier.

In a further aspect, a system that comprises an integrated circuit, a power source that is operable to power the integrated circuit, and a linear regulator that is operable to regulate a power output from the power source to the integrated circuit is disclosed. The linear regulator includes a pass element that is operable to receive an input voltage and deliver an output voltage. Additionally, the linear regulator includes a first amplifier and a second amplifier that are operable to monitor power dissipation through the pass element. Further, the first amplifier is operable to determine an output current through the pass element and the second amplifier is operable to measure a voltage drop across the pass element.

### BRIEF DESCRIPTION OF THE DRAWINGS

FIG. 1 is block-level diagram of a generic linear regulator.

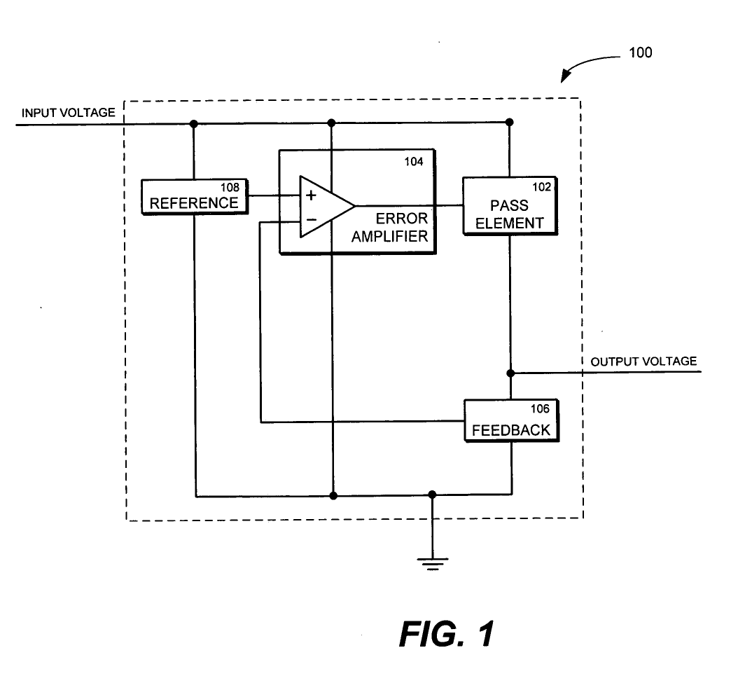

FIG. 2 illustrates a process flow of a method for managing power dissipation in a linear regulator according to an aspect of the invention.

FIG. 3 depicts a linear regulator with power dissipation management components according to one embodiment of the invention.

FIG. 4 shows another embodiment of a method for managing power dissipation in a linear regulator.

FIGS. 5A-5B are graphs showing power dissipation of exemplary linear regulators in relation to output current.

FIG. 6 illustrates a circuit diagram of a linear regulator with power dissipation management components according to another aspect of the invention.

FIG. 7 is a diagram of a system in which embodiments of the present invention can be incorporated into.

### DETAILED DESCRIPTION

The present invention relates generally to voltage regulators and more particularly to power dissipation management in linear regulators. The following description is presented to enable one of ordinary skill in the art to make and use the invention and is provided in the context of a patent application and its requirements. Various modifications to the preferred implementations and the generic principles and features described herein will be readily apparent to those skilled in the art. Thus, the present invention is not intended to be limited to the implementations shown, but is to be accorded the widest scope consistent with the principles and features described herein.

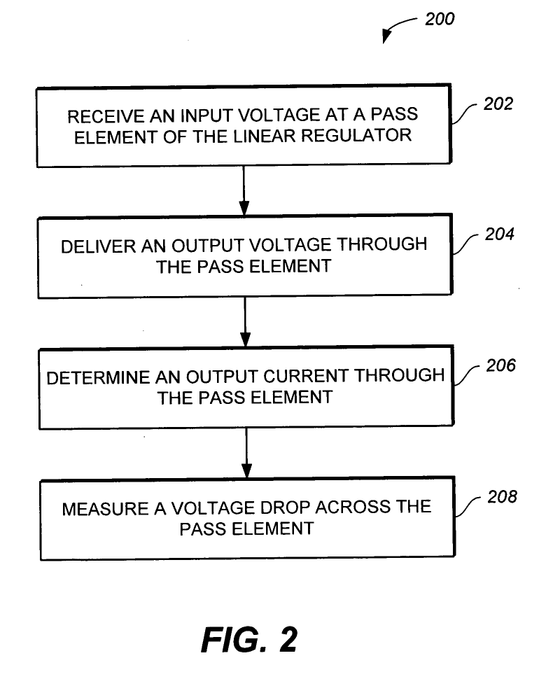

FIG. 2 depicts a process 200 for managing power dissipation in a linear regulator according to one aspect of the invention. At 202, an input voltage is received at a pass element of the linear regulator. An output voltage is then delivered through the pass element at 204. In order to monitor the amount of power dissipating through the pass element, an output current through the pass element is determined (206) and a voltage drop across the pass element is measured (208).

A pass element can be a bipolar NPN transistor, a bipolar PNP transistor, an N-channel metal-oxide semiconductor field-effect transistor (MOSFET), or a P-channel MOSFET. The type of pass element utilized is application-specific since each type has its advantages and disadvantages. For instance, a bipolar PNP transistor has a lower input to output voltage drop than a bipolar NPN transistor, but a bipolar PNP transistor also requires substantially more die area than an electrically similar bipolar NPN transistor.

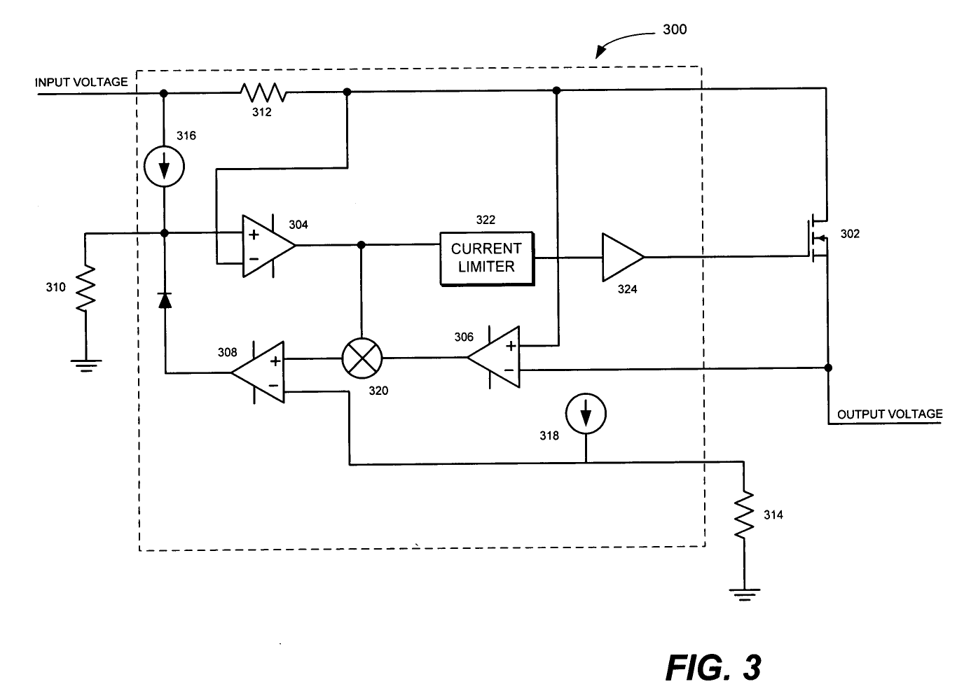

Illustrated in FIG. 3 is a linear regulator 300 according to an embodiment of the invention. Linear regulator 300 includes a pass element 302, amplifiers 304-308, resistors 310-314, current sources 316-318, a calculator 320, a current limiter 322, and a driver 324. Current limiter 322 can utilize any current limiting scheme, including, constant power, constant current, and re-entrant/foldback current limiting. Together with driver 324, current limiter 322 controls current flow through pass element 302.

Pass element 302 is operable to receive an input voltage and deliver an output voltage. In the embodiment, pass element 302 is an N-channel MOSFET. However, as noted above, a bipolar NPN transistor, a bipolar PNP transistor, or a P-channel MOSFET can be used instead. Although pass element 302 and resistors 310 and 314 are depicted to be external to linear regulator 300, they can be internal to linear regulator 300 in other embodiments.

Management of power dissipation begins with amplifiers 304 and 306 as they monitor the power dissipation through pass element 302. Amplifier 304 determines an output current through pass element 302 by comparing a drop in voltage across resistor 312 to a reference voltage set by the product of the resistance from resistor 310 and the current from current source 316. The reference voltage is adaptable depending upon the type of application utilizing linear regulator 300.

Amplifier 306 measures a voltage drop across pass element 302 by calculating the difference between the input voltage received by pass element 302 and the output voltage delivered by pass element 302. Once the output current through pass element 302 and the voltage drop across pass element 302 are known, calculator 320 will multiply the output current and the voltage drop to calculate a power dissipation value of pass element 302.

The power dissipation value of pass element 302 is then compared by amplifier 308 to a threshold set by the product of the resistance from resistor 314 and the current from current source 318. The threshold correlates to the maximum power dissipation permitted across pass element 302. In addition, the threshold can be modified to accommodate various types of devices by selecting different resistors.

When the power dissipation value exceeds the threshold, amplifier 308 will lower the output current through pass element 302 in order to maintain a constant power across pass element 302. This allows for a safer design. Furthermore, since the maximum ambient temperature, the thermal resistance of the package, and the maximum allowable power dissipation are known, no over-sizing of pass element 302 is necessary for fault conditions.

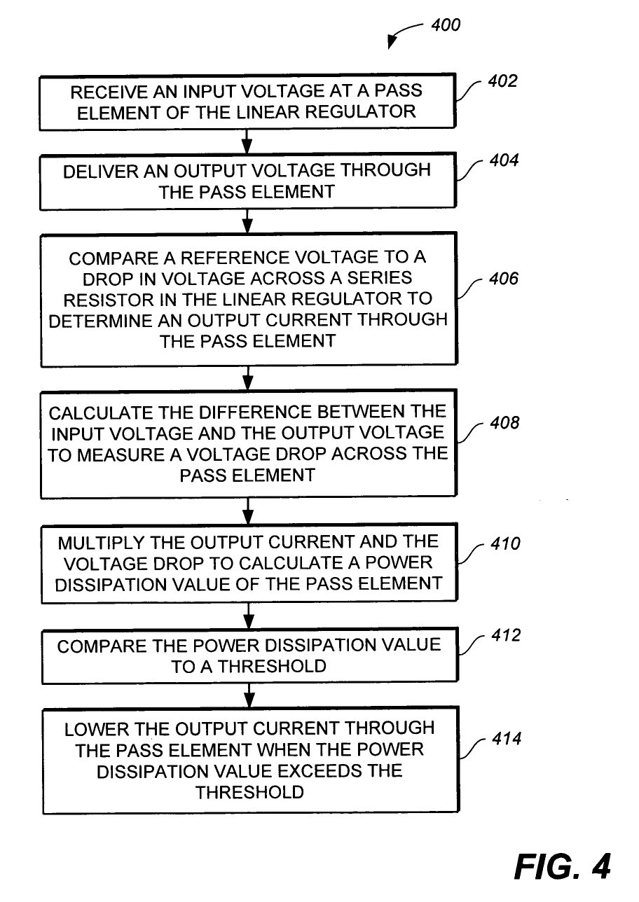

Shown in FIG. 4 is a flowchart of a process 400 for managing power dissipation in a linear regulator according to another aspect of the invention. At 402, an input voltage is received at a pass element of the linear regulator. An output voltage is then delivered through the pass element (404). A reference voltage is compared to a drop in voltage across a series resistor in the linear regulator to determine an output current through the pass element (406). The difference between the input voltage and the output voltage is calculated at 408 to measure a voltage drop across the pass element.

Once the output current through the pass element and the voltage drop across the pass element are known, they are multiplied to calculate a power dissipation value of the pass element (410). The power dissipation value is then compared to a threshold, which correlates to the maximum power dissipation permitted across the pass element (412). When the power dissipation value exceeds the threshold, the output current through the pass element is lowered (414).

In some embodiments, the output current through the pass element may not be immediately lowered when the power dissipation value exceeds the threshold. Permitting a delay before lowering the output current through the pass element can be beneficial in some applications that expect high peak current. Since temperature changes do not occur instantaneously, very short pulses where the power dissipated may exceed the threshold should not damage the pass element.

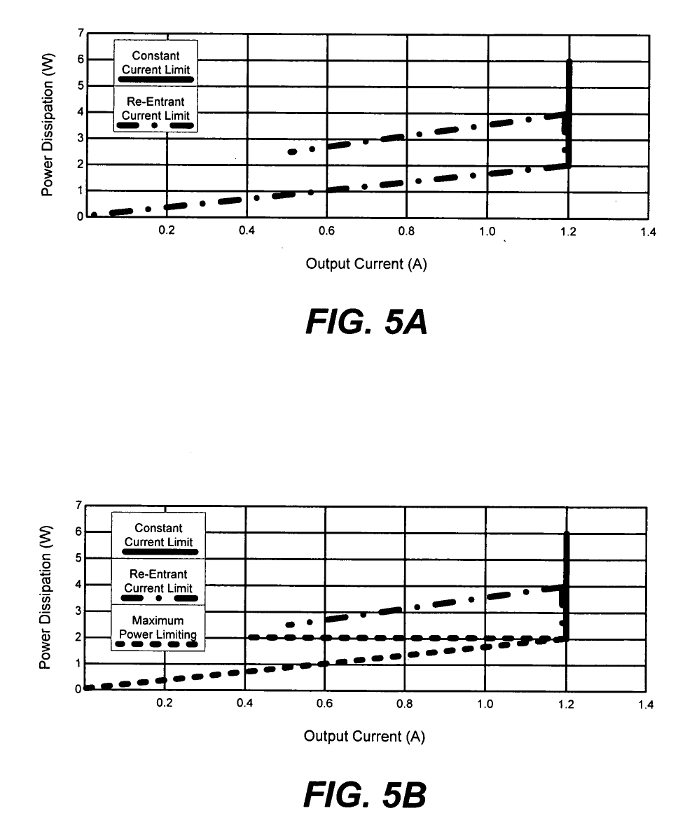

Depicted in FIGS. 5A and 5B are graphs showing power dissipation of exemplary linear regulators in relation to output current. As shown FIG. 5A, the power dissipation in exemplary linear regulators with only constant current limiting or re-entrant current limiting as circuit protection can be as high as 6 watts (W). This could damage the passing elements in the linear regulators or degrade their reliability. In contrast, the power dissipation in the same exemplary linear regulators with the addition of maximum power dissipation limiting components disclosed in various embodiments of the invention can be limited to 2W or below, as seen in FIG. 5B.

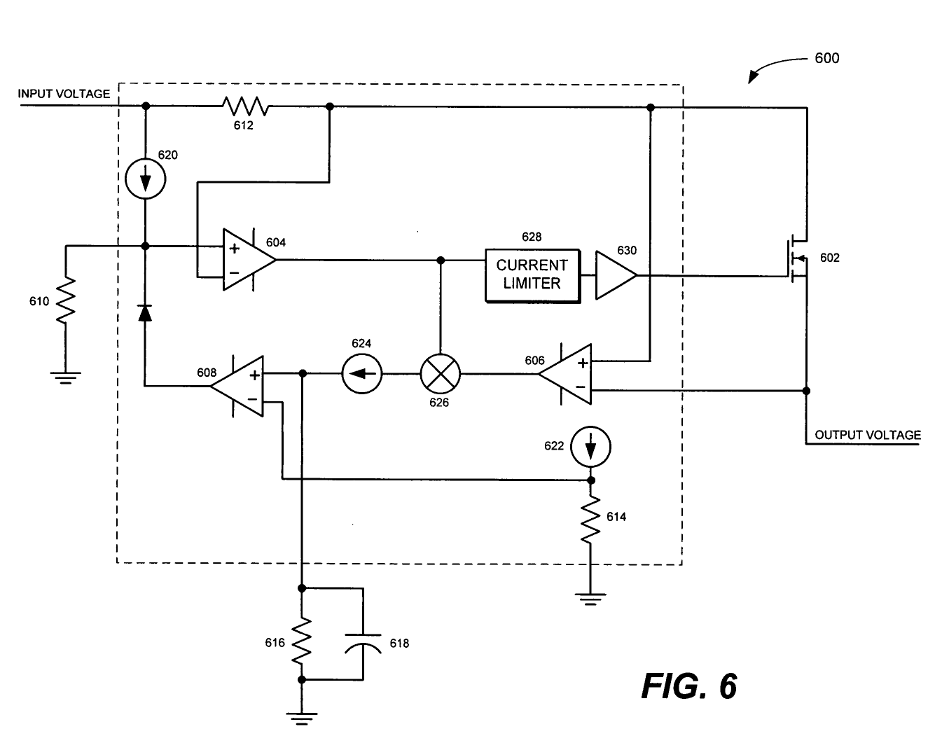

FIG. 6 illustrates a linear regulator 600 according to another embodiment of the invention. Linear regulator 600 comprises a pass element 602, amplifiers 604-608, resistors 610-616, a capacitor 618, current sources 620-624, a calculator 626, a current limiter 628, and a driver 630. Current limiter 628 can utilize any current limiting method, including, constant power, constant current, and re-entrant/foldback current limiting. Together with driver 630, current limiter 628 controls current flow through pass element 602.

Pass element 602 in linear regulator 600 is operable to receive an input voltage and deliver an output voltage. Although pass element 602 of linear regulator 600 is shown as an external N-channel MOSFET, internal or external P-channel MOSFETS, bipolar NPN transistors, and bipolar PNP transistors can be used instead. In other embodiments, linear regulator 600 may be a low dropout (LDO) regulator.

Power dissipation management in linear regulator 600 includes determining an output current through pass element 602 at amplifier 604 and measuring a voltage drop across pass element 602 at amplifier 606. Amplifier 604 determines the output current by comparing a drop in voltage across resistor 612 to a reference voltage set by resistor 610 in conjunction with current source 620. This reference voltage can be changed for different types of devices.

Amplifier 606 measures the voltage drop by calculating the difference between the input voltage received by pass element 602 and the output voltage delivered by pass element 602. Calculator 626 will then multiply the output current and the voltage drop to calculate a power dissipation value of pass element 602.

The power dissipation value is used to control current source 624, which drives resistor 616. Amplifier 608 will then compare the voltage drop across resistor 616 to a threshold set by resistor 614 in conjunction with current source 622. The threshold correlates to the maximum power dissipation allowed across pass element 602 and can be changed to accommodate various types of devices by utilizing different resistors.

When the voltage drop across resistor 616 exceeds the threshold, the output current through pass element 602 is lowered to control power dissipation. By placing capacitor 618 across resistor 616, the response time can be delayed to allow for short peaks of power across pass element 602.

Brief delays in the scaling back of the output current may be useful in applications that expect high peak currents and can therefore handle brief bursts high power dissipation. The length of delay can be modified depending on the needs of the product using linear regulator 600 by employing different capacitors.

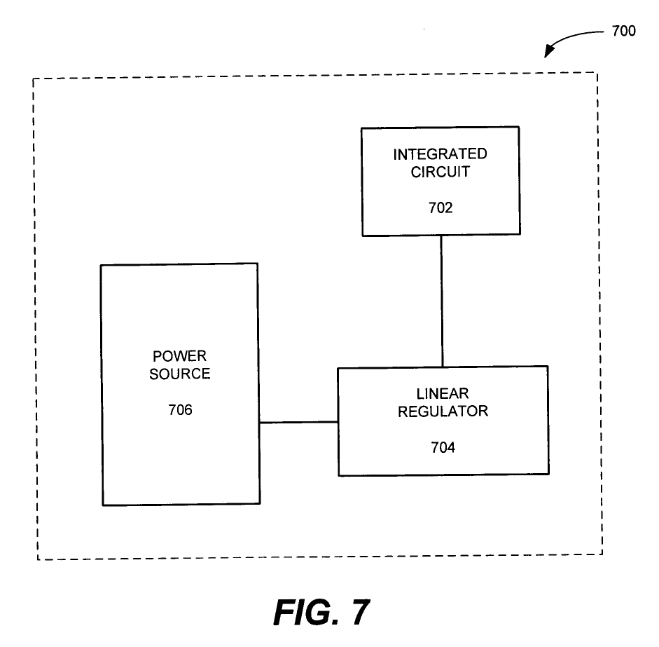

FIG. 7 is a block diagram of a system 700 suitable for incorporating an aspect of the present invention. As shown, system 700 includes an integrated circuit 702, a linear regulator 704, and a power source 706. System 700 can be any of one of a variety of devices, such as an automotive product, a portable electronic device, an industrial application, or a piece of networking equipment.

Power source 706 is operable to power integrated circuit 702 and linear regulator is operable to regulate a power output from power source 706 to integrated circuit 702. In some embodiments, power source 706 is a battery. In other embodiments, power source 706 may be a plug in an electrical outlet.

Linear regulator 704 can be one of the linear regulators described above with respect to FIGS. 3 and 6 or a variation thereof. According to an aspect of the invention, linear regulator 704 contains a pass element that is operable to receive an input voltage and deliver an output voltage and a first amplifier and a second amplifier that are operable to monitor power dissipation through the pass element. Power dissipation may be monitored by determining an output current through the pass element at the first amplifier and measuring a voltage drop across the pass element at the second amplifier.

In other embodiments, linear regulator 704 also includes a resistor, a calculator that calculates a power dissipation value of the pass element by multiplying the output current through the pass element and the voltage drop across the pass element, and a third amplifier that lowers the output current through the pass element when the power dissipation value exceeds a threshold set by the resistor. Further embodiments of linear regulator 704 may include a capacitor that delays the lowering of the output current through the pass element by the third amplifier.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A method of managing power dissipation in linear regulators, the method comprising:
receiving an input voltage at a pass element of a linear regulator;
delivering an output voltage through the pass element;
determining an output current through the pass element; and
measuring a voltage drop across the pass element.

2. The method of claim 1, wherein
determining the output current through the pass element comprises comparing a reference voltage to a drop in voltage across a series resistor in the linear regulator to determine the output current through the pass element, and
measuring the voltage drop across the pass element comprises calculating the difference between the input voltage and the output voltage to measure the voltage drop across the pass element.

3. The method of claim 1, further comprising:
multiplying the output current and the voltage drop to calculate a power dissipation value of the pass element;
comparing the power dissipation value to a threshold, wherein the threshold correlates to the maximum power dissipation permitted across the pass element; and
lowering the output current through the pass element when the power dissipation value exceeds the threshold.

4. The method of claim 3, wherein the output current through the pass element is not immediately lowered when the power dissipation value exceeds the threshold.

5. The method of claim 1, wherein the pass element is a bipolar NPN transistor, a bipolar PNP transistor, an N-channel MOSFET, or a P-channel MOSFET.

6. The method of claim 1, wherein the linear regulator is a low dropout (LDO) regulator.

7. The method of claim 1, wherein the pass element is external to the linear regulator.

8. A linear regulator comprising:
a pass element, the pass element being operable to receive an input voltage and deliver an output voltage; and
a first amplifier and a second amplifier, the first amplifier and the second amplifier being operable to monitor power dissipation through the pass element, wherein
the first amplifier is operable to determine an output current through the pass element, and
the second amplifier is operable to measure a voltage drop across the pass element.

9. The linear regulator of claim 8, further comprising:
a first resistor; and
a second resistor, wherein the first amplifier compares a reference voltage set by the first resistor to a drop in voltage across the second resistor to determine the output current through the pass element.

10. The linear regulator of claim 8, wherein the second amplifier calculates the difference between the input voltage and the output voltage to measure the voltage drop across the pass element.

11. The linear regulator of claim 8, further comprising:
a resistor;
a calculator, the calculator being operable to calculate a power dissipation value of the pass element by multiplying the output current through the pass element and the voltage drop across the pass element; and
a third amplifier, the third amplifier being operable to compare the power dissipation value to a threshold set by the resistor and lower the output current through the pass element when the power dissipation value exceeds the threshold.

12. The linear regulator of claim 11, further comprising:
a capacitor, the capacitor being operable to delay the lowering of the output current through the pass element by the third amplifier.

13. The linear regulator of claim 8, wherein the pass element is a bipolar NPN transistor, a bipolar PNP transistor, an N-channel MOSFET, or a P-channel MOSFET.

14. The linear regulator of claim 8, wherein the linear regulator is a low dropout (LDO) regulator.

15. The linear regulator of claim 8, wherein the pass element is external to the linear regulator.

16. A system comprising:
an integrated circuit;
a power source, the power source being operable to power the integrated circuit; and
a linear regulator, the linear regulator being operable to regulate a power output from the power source to the integrated circuit, wherein the linear regulator comprises
a pass element, the pass element being operable to receive an input voltage and deliver an output voltage, and
a first amplifier and a second amplifier, the first amplifier and the second amplifier being operable to monitor power dissipation through the pass element, wherein
the first amplifier is operable to determine an output current through the pass element, and
the second amplifier is operable to measure a voltage drop across the pass element.

17. The system of claim 16, wherein the linear regulator further comprises:
a resistor;
a calculator, the calculator being operable to calculate a power dissipation value of the pass element by multiplying the output current through the pass element and the voltage drop across the pass element;
a third amplifier, the third amplifier being operable to compare the power dissipation value to a threshold set by the resistor and lower the output current through the pass element when the power dissipation value exceeds the threshold; and
a capacitor, the capacitor being operable to delay the lowering of the output current through the pass element by the third amplifier.

18. The system of claim 16, wherein the pass element is external to the linear regulator.

19. The system of claim 16, wherein the power source is a battery.

20. The system of claim 16, wherein the integrated circuit is associated with an automotive product, a portable electronic device, an industrial application, or a piece of networking equipment.
